(19) United States
(12) Patent Application Publication
(10) Pub. No.: US 2005/0199571 A1
(43) Pub. Date: Sep. 15, 2005

(54) Container with interior decoration

(75) Inventors: Stefan Geisler, Sarstedo (DE); David Bain, Gaytou (GB); Lars Bewig, Bad Gandersheim (DE); Christoph Moelle, Bad Gandersheim (DE); Thomas Kuepper, Bad Gandersheim (DE)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Schott AG

(21) Appl. No.: 11/031,557

(22) Filed: Jan. 7, 2005

(30) Foreign Application Priority Data
Jan. 9, 2004 (DE) 10 2004 001603.8-

(51) Int. Cl. A47J 41/02; B65D 90/02; B65D 23/00

(52) U.S. Cl. 215/12.1; 215/379

(57) ABSTRACT

A container having an at least partly transparent hollow body and a decoration is provided. The decoration includes at least one interior lining of the hollow body so that reactions between ingredients of a product situated in the container and constituents of the decoration are prevented.

The invention relates to a container, especially a scent bottle, which comprises an at least partly transparent hollow body and a decoration, in accordance with the preamble of claim 1 or as claimed in claim 2.

In order to furnish a packaging material it is possible to provide containers which comprise a hollow body which is open toward the surroundings at the container opening. Packaging materials chosen are frequently transparent, in which case not only glass but also, increasingly, transparent plastics are used as hollow bodies. Transparent packaging containers, especially for applications in the cosmetics industry, such as for scent bottles, for example, may have decorations. Thus containers of the same construction may be used for different contents by means of a differently decorated outer surface.

A disadvantage in this context, however, is that the design latitude for the containers is limited. What would be desirable, therefore, would be a possibility of designing a packaging container that is not restricted to the shaping of the packaging container and the application of a decoration to its outer surface. It is therefore one object of the invention to expand the design possibilities for containers, especially scent bottles.

Decorations frequently comprise varnishes. One meaning of the term “varnish” is that of a dispersion which has at least one functional constituent which is in distribution, i.e., dispersion, in a liquid. The liquid may be water or another solvent, in particular an organic solvent. The functional constituent may itself be in liquid form, so that the varnish is an emulsion, or in solid form, so that the varnish is a suspension.

After the dispersion has been applied to the surface to be varnished the varnish coating dries, so that the liquid evaporates and a coating is produced in the form of a varnish layer which comprises the particles of the functional constituent. The functional constituent may for example be a color pigment. The term “varnish” also embraces powder coating materials, where the functional constituent is present not in a dispersion in a liquid but rather in a powder.

Where decorations are to be applied to the interior surface of a container, however, and especially when the decoration comprises a varnish layer, the disadvantage arises that the materials used for the decoration may be attacked by ingredients of the product accommodated in the container in question. As a consequence of this the ingredients may be decomposed and/or give rise to unwanted reaction products. By way of example, active substances in cosmetic or pharmaceutical products, or essences of a perfume, may be degraded and/or converted into interfering substances.

As a result of the corresponding reaction products, moreover, there is a risk of substances harmful to the consumer being produced. Post-production quality control may possibly not detect these substances, since they are only produced with ongoing storage time. Especially in the case of products with long shelf lives, such as are often required of cosmetics, the risk for the consumer is therefore increased.

The invention is therefore based additionally on the object of providing a container, in particular a scent bottle, which has a decoration but for which reaction between ingredients of a product located in the container and constituents of the decoration can be substantially ruled out.

These objects are achieved in a surprisingly simple way by means of a container having the features of claims 1 or 2. Advantageous developments are found in the associated subclaims.

The invention provides a container, especially a scent bottle, which comprises an at least partly transparent hollow body and a decoration, the decoration comprising at least one interior lining of the hollow body.

The design latitude for the containers is significantly expanded by the invention, by virtue of the advantageous lifting of the restriction on the shaping of the container and the applying of a decorative layer to its outer surface.

The term “hollow body” refers for the purposes of the present specification to a body which has walls which define at least one cavity. At least one cavity of a hollow body of this kind has an opening to the outside.

The term “decoration” refers in the context of the present specification to a constituent of the container that produces an optical effect which contributes to the overall visual impression of the container. By way of example the decoration may be colored.

The term “lining” refers in the context of the present specification to a hollow body which is joined at one place at least to the at least partly transparent hollow body. The lining may be a coating of the at least partly transparent hollow body. This means that the decoration can be in two-dimensional contact with said hollow body. In particular the decoration may comprise an interior coating of the at least partly transparent hollow body.

Alternatively the lining can be configured as a further hollow body which is joined at one place at least to the at least partly transparent hollow body. It will be appreciated that the invention also embraces the arrangement of more than two hollow bodies one inside another.

The reference “interior” in connection with the site of the lining in the container identifies for the purposes of the present specification a site on the inside of the hollow body and/or within the walls of the hollow body.

Siting the decoration on the inside of the hollow body which is provided for accommodating the contents of the container is especially appropriate when there is no likelihood of problems due to reactions between the decoration and the container contents.

Siting the decoration within the walls of the hollow body is appropriate when such problems do occur.

In principle it is possible to manufacture the container of the invention in such a way that a proto-container is produced first of all. The proto-container may have the decoration or may itself constitute the decoration. In a subsequent step an assembly can be produced from the proto-container with the at least partly transparent hollow body. By way of example the decoration can be provided exteriorly with a transparent coating.

It is, however, also possible to produce an at least partly transparent hollow body into which the decoration is introduced. This can be done, for example, by applying a decorative coating to the inside of the at least partly transparent hollow body.

A further possibility for producing the container of the invention consists in manufacturing different vessels, of which at least one comprises a decoration, and arranging these vessels one inside another and joining them to one another at one place at least, such as in the region of the opening, for example. The individual vessels may also be joined each at different places to the respectively adjacent vessels.

Thus the decoration used may comprise at least one hollow body, a colored hollow body for example, which is arranged in a transparent hollow body. The decoration here may in particular itself constitute the vessel which is provided for accommodating the contents of the container. Alternatively at least one further container may be arranged in the decoration, serving to accommodate the container contents.

Where there is a problem, particularly in the case of scent bottles, of possible reactions between the decoration and the container contents with unwanted products, the invention offers the solution of being able to prevent such reactions substantially completely by shielding the decorative layer from the container contents.

For this purpose a container is provided which comprises a hollow body, the hollow body having an at least partly transparent first region and having at least on the inside of the first region in at least one second region a decoration, and a third region which joins the first region and/or the second region.

The expression “adjoining” for the third region refers to a siting which takes place in adjacency to the first and/or second region in such a way that direct contact is possible between the regions in question but also an adjacent arrangement of the regions, with a space between them, is possible.

In an advantageous development the third region may comprise a barrier layer. In this way it is possible specifically to avoid, substantially, diffusion of components of the container contents through the container walls. Since in that case the contact of the components of the container contents with the material of the decoration, in particular, is almost completely prevented, the probability of reactions between components of the container contents and material of a decoration is extremely small, and so the formation of unwanted substances can be virtually ruled out.

For applying the barrier layer it is possible to employ any of a very wide variety of methods, such as varnishing or vacuum methods such as sputtering, electron beam evaporation, and also PVD (physical vapor deposition) or CVD (chemical vapor deposition) techniques, especially PECVD (plasma enhanced chemical vapor deposition) techniques, examples being PICVD (plasma impulse chemical vapor deposition) techniques.

In connection with the thermal load as a result of the coating technique, especially when coating decorations which include organic constituents, it must be ensured that the temperature during coating does not become too high, in order to ensure that the decoration does not soften and as a result, for example, change its shape or even detach from the substrate.

When a CVD (chemical vapor deposition) technique is used, particularly in the case of a PECVD (plasma enhanced chemical vapor deposition) technique and especially in the case of a PICVD (plasma impulse chemical vapor deposition) technique, however, the layers can be deposited at low temperatures, in particular at temperatures below the glass transition temperature of plastics. Rapidly changing the process gas, moreover, advantageously allows the application even of very thin layers.

Besides the at least one precursor the process gas may comprise further gases, especially reactive gases such as oxygen, and, if desired, carrier gases, namely inert gases such as nitrogen or noble gases.

Examples of suitable precursor materials include silanes, siloxanes, and silazanes. Depending on the composition of the precursor gas it is possible to deposit barrier layers differing in composition. Only by way of example, therefore, the barrier layer may comprise SiO₂ and/or TiO₂. In particular, however, barrier layers with a nonstoichiometric composition are also within the scope of the invention. Can we provide further specific compounds which may be present in the barrier layer?

In principle it is possible to use in particular the following compounds: methylsilane, dimethylsilane, trimethylsilane, diethylsilane, propylsilane, phenylsilane, hexamethyldisilane, 1,1,2,2-tetramethyldisilane, bis(trimethylsilyl)methane, bis(dimethylsilyl)methane, hexamethyldisilane, vinyltrimethoxysilane, vinyltriethoxysilane, ethylmethoxysilane, ethyltrimethoxysilane, divinyltetramethyldisiloxane, divinylhexamethyltrisiloxane and trivinylpentamethyltrisiloxane, 1,1,2,2-tetramethyldisiloxane, hexamethyldisiloxane, vinyltrimethylsilane, methyltrimethoxysilane, vinyltrimethoxysilazane and hexamethyldisilazane.

Preferred silicon compounds are tetramethyldisiloxane, hexamethyldisiloxane (HMDSO), hexamethyldisilazane, tetramethylsilazane, dimethoxydimethylsilane, methyltrimethoxysilane, tetramethoxysilane, methyltriethoxysilane, diethoxydimethylsilane, methyltriethoxysilane, triethoxyvinylsilane, tetraethoxysilane, dimethoxymethylphenylsilane, phenyltrimethoxysilane, 3-glycidyloxypropyltrimethoxysilane, diethoxymethylphenylsilane, tris(2-methoxyethoxy)vinylsilane, phenyltriethoxysilane, and dimethoxydiphenylsilane.

The invention therefore offers, advantageously, the possibility of the decoration being masked substantially completely from the interior of the hollow body, in particular by means of the barrier layer. Contact between the constituents of the decoration and the ingredients of the product to be introduced in the container of the invention is therefore almost completely ruled out.

Advantageously this effect can be achieved with just a single barrier layer. The thickness of material in the third region can therefore, advantageously, be chosen to be very low. In particular the invention provides for the barrier layer to have a thickness of at least 20 nm.

For the barrier layer it is possible in the context of the invention to choose, in principle, any desired materials. By way of example the barrier layer may comprise at least one layer which comprises SiO₂. A very good barrier effect is also achieved when the barrier layer comprises at least one layer which comprises TiO₂.

In principle it is not necessary in the context of the invention to obtain a stoichiometric composition, particularly of the barrier coating. Instead the barrier coating may also include components, or be constructed completely from materials, which have a nonstoichiometric composition. The composition of the relevant regions and/or layers may be adjusted in particular when employing a CVD technique through the choice of the precursor gas and its concentration.

The barrier layer may further comprise a multilayer system composed of at least two layers. For instance it is possible to adapt one layer, which is in contact with the decoration, in terms of its composition, with a view, for example, to maximum adhesion to the materials of the decoration, while a layer which is in contact with the products to be introduced in the container can be selected with a view to a maximum blocking effect, particularly with respect to components of a kind which can enter into unwanted reactions with constituents of the decoration.

For the hollow body it is possible to choose different materials in accordance with the specific application and desired properties of the container in terms of strength, transparency, corrosion resistance, and tactuality. By way of example the hollow body may comprise at least one glass. In the context of the invention it is also possible, however, for the hollow body to comprise at least one plastic.

The invention further provides for the decoration to comprise a varnish layer, in particular an epoxy varnish layer. A layer may be applied in a simple way, by—for example—introducing a varnish into the interior of a hollow body, distributing it and taking off any excess, and curing the resulting layer in the inside of a hollow body.

At the same time, advantageously, the possibility exists of selecting a varnish coating which is suitable for the specific application, from the multiplicity of varnishes available commercially, with a view to the desired design and, possibly, to material-specific circumstances, with regard to the adhesion of the varnish layer on the support material and also to possible interactions of the varnish layer with materials with which it is in contact.

A further possibility for designing the container of the invention consists in the decoration comprising a unicolored decorative layer. By way of example the decoration may have a black decorative layer. This distinguishes the region of the container that is surrounded by the decoration from the exterior contour of the at least partially transparent container in a particularly distinctive way. The decoration may also comprise a multicolored decorative layer, so that additional optical effects can be achieved.

Where different varnishes with different components are used for a multicolored coating of this kind, the possibility is provided in the context of the invention, in a surprisingly simple way, of jointly corrosion-protecting those components of the varnishes that are problematic from the standpoint of unwanted reactions with the container contents by means of a single protective layer, in particular by means of a barrier layer. It is therefore, advantageously, unnecessary to provide each individual varnish with a specific protective layer matched to it.

An even more advanced optical design of the container of the invention is made possible in a simple way by means of the wall thickness D₁ of the hollow body in at least one first section not coinciding with the wall thickness D₂ in at least one second section. The wall thickness, in other words, can vary, so that the form of one interior region, particularly of a region configured as a hollow body for accommodating the product to be introduced into the container, may differ from the exterior form of the container. Accordingly a design in the form of any desired bodies arranged one inside another is made possible by adaptation of the respective exterior profiles.

The invention is illustrated below by means of exemplary embodiments, with reference to the attached figures. In all figures the same components are designated by the same reference numerals.

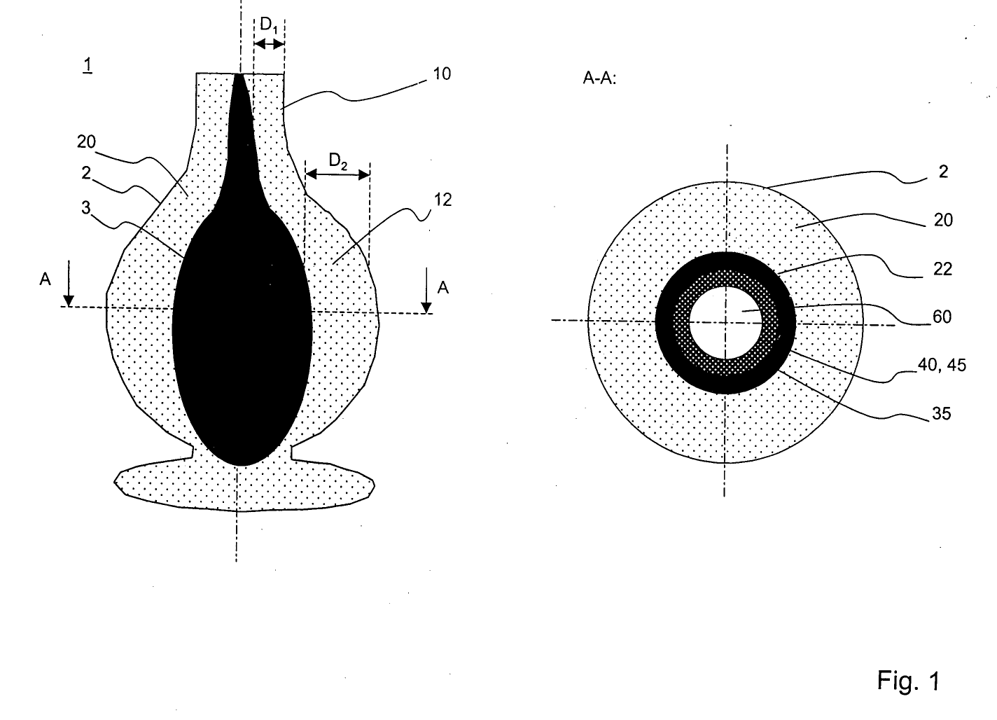

FIG. 1 shows a diagrammatic representation of a container of the invention according to a first embodiment, in front elevation and in cross section,

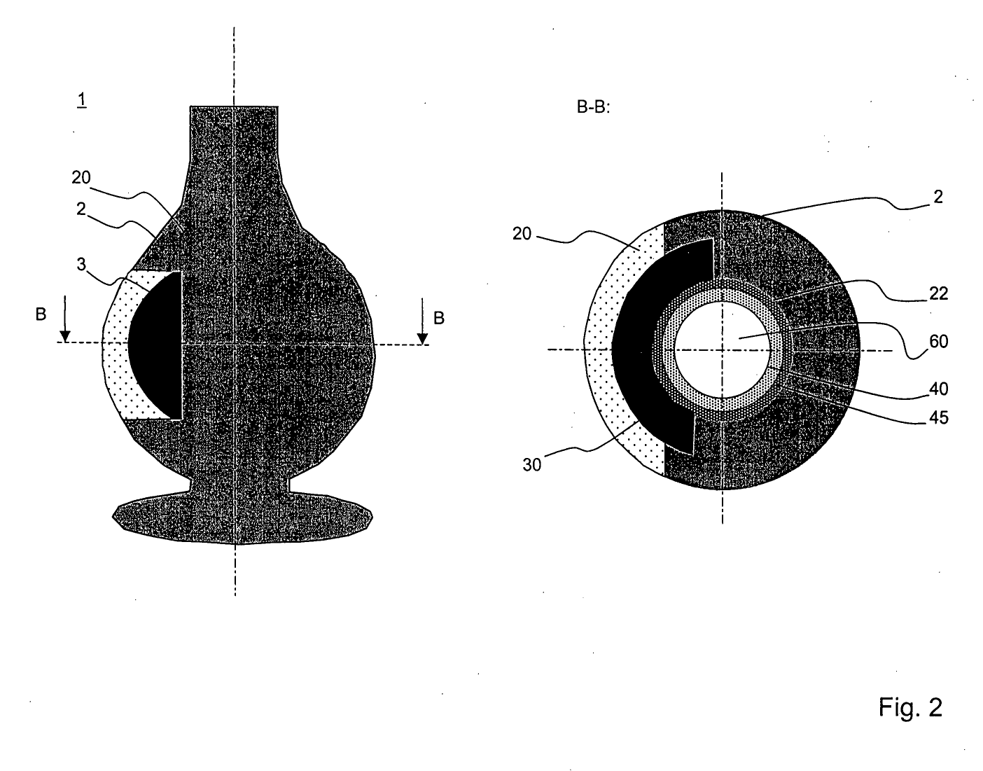

FIG. 2 shows a diagrammatic representation of a container of the invention according to a second embodiment, in front elevation and in cross section,

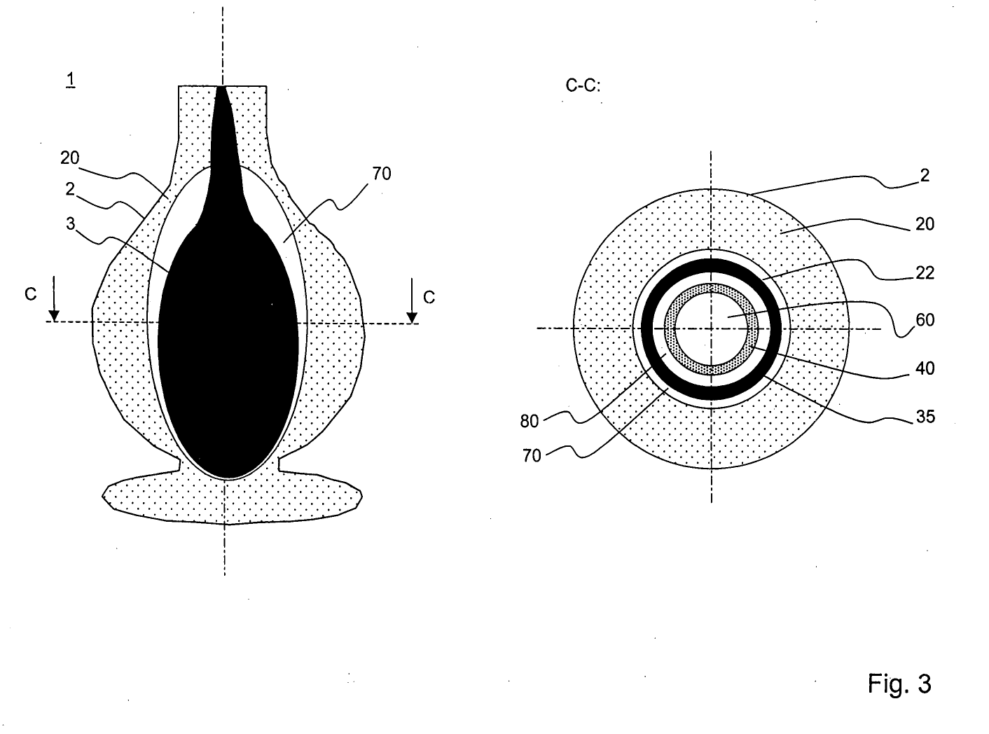

FIG. 3 shows a diagrammatic representation of a container of the invention according to a third embodiment, in front elevation and in cross section.

FIGS. 1, 2 and 3 show a container 1 of the invention in different embodiments. In the figures a scent bottle has been depicted diagrammatically, as an example of a container 1 of the invention. As will be appreciated, however, the invention relates not exclusively to scent bottles, but is instead able to provide any desired varieties of decorated containers.

FIG. 1 depicts a container 1 according to a first embodiment. It comprises a hollow body 2 having a transparent region 20, which in the present first exemplary embodiment comprises the entire container walls of the hollow body. The container further comprises a decoration 3 which is arranged on the inside 22 of the hollow body 2.

The decoration 3 forms a lining 35 which according to the first exemplary embodiment coats the inside 22 of the hollow body 2. This arrangement is apparent from the cross-sectional representation on the right-hand side in FIG. 1, which depicts a cross section along the line A-A.

Interiorly adjoining the decoration 3 with its lining 35 is a region 40, which in the first exemplary embodiment is configured as a barrier layer 45. The barrier layer 45 closes off the interior lining 35 of the decoration 3 with respect to the interior 60 of the container 1. In this way contact between components of a product which may be present in the interior 60 of the container 1 and components of the decoration 3 in the form of the interior lining 35 is almost completely avoided. The formation of unwanted reaction products is therefore almost entirely ruled out.

By shaping of the walls of the interior 60 of the container 1 it is possible to design the optical impression of the container further, as well as by means of the different color impression shown by the decoration in the transparent hollow body.

In particular it is not necessary for the exterior contour of the interior region 60 to coincide with the exterior contour of the container 1 itself. This can be achieved in a simple way by the hollow body 2 having regions 10, 12 which differ in their wall thickness. In the first exemplary embodiment, for example, the wall thickness D₁ in a neck region 10 of the container 1 is smaller than the wall thickness D₂ in a region 12 at mid-height of the container 1.

In the first exemplary embodiment the entire hollow body 2 is designed transparently, so that the interior 60 lined with the decoration 3 is visible as a contour from any direction from which the container is viewed.

FIG. 2 depicts a second embodiment of the invention, in which the container 1 has an only partly transparent first region 20. In the transparent region of the partly transparent region 20 the decoration 3, arranged in the hollow body 2, is apparent. The sectional view along a cross section B-B shows the second region 30 which is arranged on the inside 22 of the hollow body 2 and comprises the decoration 3.

Unlike the first embodiment, shown in FIG. 1, the second exemplary embodiment, depicted in FIG. 2, makes it clear that in the context of the invention the decoration 3 need not necessarily fill a region situated comprehensively in adjacency to the outer surface of the interior region 60 of the container 1. Instead it is likewise within the scope of the invention for only a subregion of the walls of the container 1 to be designed, by arrangement of a region 30 which comprises a decoration 3, in such a way that the decoration is visible in said region.

Using as an example the second embodiment of the invention it is further shown, in the sectional view B-B, that a region 40 which adjoins the at least partly transparent first region 20 and the second region 30 comprising the decoration 3 may comprise a multilayer system, which in the second exemplary embodiment shown has a barrier layer 45. In this way the decoration 3 is masked completely from the interior 60 of the hollow body, in particular by means of the barrier layer 45.

In the embodiments depicted in FIGS. 1 and 2 radially adjacent regions are each arranged in direct contact with one another. In the context of the invention, however, further possibilities are also provided for the arrangement of the regions.

Accordingly FIG. 3 depicts a third embodiment of the container 1 of the invention, in which the hollow body 2 is lined interiorly without direct contact between an interior lining 35, which comprises the decoration 3, and the inside 22 of the first region 20 of the hollow body and the region 40. Instead such direct contacts exists only in certain places.

In the example shown the hollow bodies arranged one inside another, which are formed by the interior lining 35 and/or the region 40, are joined to one another, in the region of the neck of the container 1, in such a way that their respective site in the container 1 is fixed. Outside this region in which the identified hollow bodies 35 and 40 are joined to one another—thus, for example, in a cross-sectional region C-C—there is a cavity 70 between the interior lining 35 and the inside 22 of the hollow body 2, and a cavity 80 between the region 40 and the interior lining 35.

The radial dimensions of the cavities 70, 80 may vary over the height of the container 1 and, viewed radially, may adopt different values. As a consequence of the resultant different exterior contours through different regions, and the arrangement thereof within one another, the diversity of design possibilities for corresponding containers 1 is further increased.

1. A container comprising:
an at least partly transparent hollow body; and
a decoration formed as at least one interior lining of the hollow body.

2. A container comprising:
a hollow body having an at least partly transparent first region;
a decoration on an inside of the hollow body in at least one second region of the hollow body; and
a third region joined to the at least partly transparent first region and/or at least one second region.

3. The container as claimed in claim 2, wherein the third region comprises a barrier layer.

4. The container as claimed in claim 3, wherein the decoration is masked substantially completely from an interior of the container by the barrier layer.

5. The container as claimed in claim 3, wherein the barrier layer has a thickness of at least 20 nm.

6. The container as claimed in claim 3, wherein the barrier layer comprises at least one layer comprising SiO₂.

7. The container as claimed in claim 3, wherein the barrier layer comprises at least one layer comprising TiO₂.

8. The container as claimed in claim 3, wherein the barrier layer comprises a multilayer system of having at least two layers.

9. The container as claimed in claim 1, wherein the hollow body comprises glass.

10. The container as claimed in claim 1, wherein the hollow body comprises plastic.

11. The container as claimed in claim 1, wherein the decoration comprises a varnish layer.

12. The container as claimed in claim 1, wherein the decoration comprises a unicolored decorative layer.

13. The container as claimed in claim 1, wherein the decoration comprises a multicolored decorative layer.

14. The container as claimed in claim 1, wherein the hollow body has a first wall thickness in at least one first section and a second wall thickness in at least one second section, wherein the first wall thickness does not coincide with the second wall thickness.

15. The container as claimed in claim 2, wherein the hollow body comprises glass or plastic.

16. The container as claimed in claim 2, wherein the decoration comprises a unicolored decorative layer or a multicolored decorative layer.

17. The container as claimed in claim 2, wherein the hollow body has a first wall thickness in a first section and a second wall thickness in a second section, wherein the first wall thickness does not coincide with the second wall thickness.
